(19) United States
(12) Patent Application Publication
(10) Pub. No.: US 2025/0074066 A1
(43) Pub. Date: Mar. 6, 2025

(54) LIQUID EJECTION HEAD AND LIQUID EJECTION APPARATUS

(71) Applicant: CANON KABUSHIKI KAISHA, Tokyo (JP)

(72) Inventor: YUMI KOMAMIYA, Kanagawa (JP)

(21) Appl. No.: 18/818,106

(22) Filed: Aug. 28, 2024

(30) Foreign Application Priority Data
Aug. 29, 2023 (JP) 2023-138733

(51) Int. Cl. B41J 2/175; B41J 2/045; B41J 2/14

(52) U.S. Cl. CPC B41J 2/17563; B41J 2/045; B41J 2/14; B41J 2/17523

(57) ABSTRACT

The present disclosure provides a liquid ejection head including: multiple printing element substrates for ejecting a liquid; a flow path member having a common flow path in fluid communication with the multiple printing element substrates; and a liquid supply unit that supplies the liquid to the flow path of the flow path member, the liquid supply unit being disposed on an opposite side of the flow path member from the printing element substrates, wherein a length of the liquid supply unit in a longitudinal direction is shorter than a length of the flow path member in the longitudinal direction, and a center of the liquid supply unit in the longitudinal direction is disposed closer to an upstream side of the common flow path than a center of the flow path member.

### BACKGROUND OF THE DISCLOSURE

### Field of the Disclosure

The present disclosure relates to a liquid ejection head and a liquid ejection apparatus, and more particularly, to a configuration for temperature management of a liquid ejection head.

### Description of the Related Art

Some liquid ejection heads, such as printing heads that eject ink, are provided with a filter on the upstream side of the head body to prevent clogging of the ejection portion, and a negative pressure generating mechanism to control the liquid pressure of the ejection portion within a predetermined range.

Full-line heads, commonly referred to as those in which ejection openings are arranged over the width direction of a printing medium to be conveyed, tend to have a large filter area because of a large ejection flow rate. Further, a nozzle circulation configuration for circulating ink to the ejection portion may be employed; in this case, negative pressure generating mechanisms are often installed on both the upstream side and the downstream side of the ejection portion. As a result, there is a problem that the head becomes large. On the other hand, as described in Japanese Patent Laid-Open No. 2019-10757 (hereinafter referred to as Literature 1), a configuration is known in which a filter, a negative pressure generating mechanism, and distribution flow paths connecting these to the head body are arranged close to the upper part of the head body, thereby achieving downsizing.

However, in the configuration disclosed in Literature 1, since the ink passes through the distribution flow path and the filter flow path, which are in contact with almost the entire ejection head before flowing into the head body, the heat generated by the ejection operation of the ejection head is transferred to the ink, and the temperature of the ink rises. As a result, the temperature of the ink flowing into the head body also increases, and the temperature of the ink at the ejection portion increases. Then, there is a possibility of causing problems such as an increase in viscosity due to evaporation of the ink and a change in color material concentration.

### SUMMARY OF THE DISCLOSURE

A liquid ejection head according to one aspect of the present disclosure includes: multiple printing element substrates for ejecting a liquid; a flow path member having a common flow path in fluid communication with the multiple printing element substrates; and a liquid supply unit that supplies the liquid to the flow path of the flow path member, the liquid supply unit being disposed on an opposite side of the flow path member from the printing element substrates, wherein a length of the liquid supply unit in a longitudinal direction is shorter than a length of the flow path member in the longitudinal direction, and a center of the liquid supply unit in the longitudinal direction is disposed closer to an upstream side of the common flow path than a center of the flow path member.

Further features of the present disclosure will become apparent from the following description of exemplary embodiments with reference to the attached drawings.

### BRIEF DESCRIPTION OF THE DRAWINGS

FIG. 1 is a diagram illustrating an example of a liquid ejection apparatus;

FIG. 2 is a conceptual diagram of a control system;

FIG. 3 is a schematic diagram of an ink supply system;

FIGS. 4A and 4B are perspective views of a liquid ejection head;

FIG. 5 is an exploded view of the liquid ejection head;

FIGS. 6A and 6B are exploded views of a liquid supply unit;

FIGS. 7A to 7D are exploded views of a flow path member;

FIGS. 8A and 8B are a perspective view and a cross-sectional view of a flow path;

FIGS. 9A and 9B are a perspective view and an exploded view of an ejection module;

FIGS. 10A to 10C are perspective views of a printing element substrate;

FIG. 11 is a cross-sectional view of the printing element substrate; and

FIGS. 12A and 12B are schematic diagrams of temperature control areas of the printing element substrate.

### DESCRIPTION OF THE EMBODIMENTS

Examples of embodiments of the present disclosure will be described below with reference to the drawings. However, the following description does not limit the scope of the present disclosure. As an example, the present embodiment adopts a thermal system where a heating element generates bubbles to eject liquid; however, the present disclosure can also be applied to a liquid ejection head that adopts a piezo system or other various liquid ejection systems.

### First Embodiment

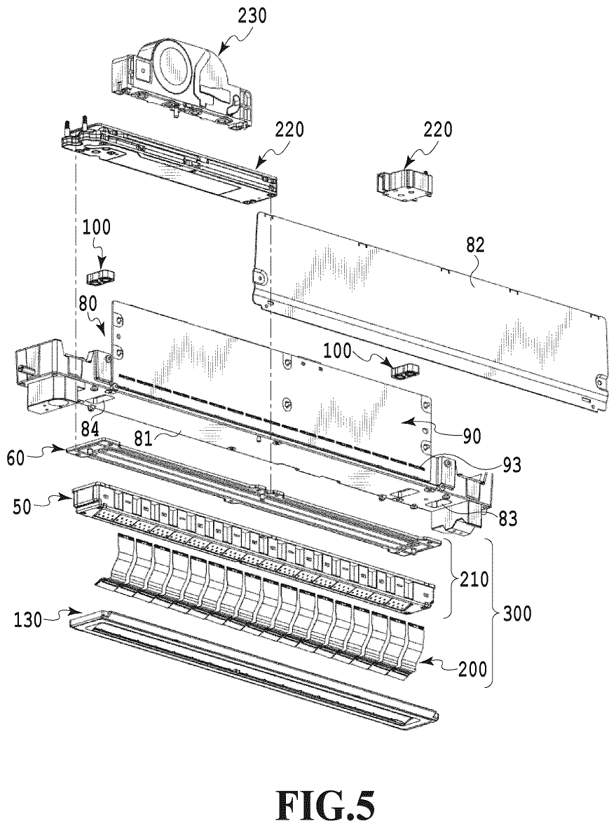

First, the increase in temperature of the ink flowing into the head body, which is to be solved by the embodiment of the present disclosure, will be described in detail. The printing element substrate constituting the head body includes a heating element, and the temperature thereof rises due to driving of the heating element accompanying the ejection operation. Therefore, the flow path member that is directly or indirectly joined to the printing element substrate, for example, the first flow path member 50 and the second flow path member 60 shown in FIG. 5, is heated by receiving heat from the printing element substrate constituting the ejection module 200. As a result, heat is transferred from the liquid flow path members 50 and the like to the liquid supply unit disposed on the upper side (the opposite side to the ejection module 200) of the second flow path member 60 in the figure, and the ink is heated in the liquid supply unit. Further, since the heat is carried to one side (downstream side) in the direction in which the liquid flow path members 50 and 60 extend by the flow of the ink in the flow path inside the liquid flow path member 50, the temperature rise at the supply unit becomes more notable when the liquid supply unit abuts on the downstream flow path member. As a result, the temperature of the ink flowing into the head body rises, which causes problems such as an increase in viscosity due to evaporation of the ink.

Hereinafter, an embodiment of the present disclosure for solving the above-described problems will be described in detail.

### <Overall Configuration of Liquid Ejection Apparatus>

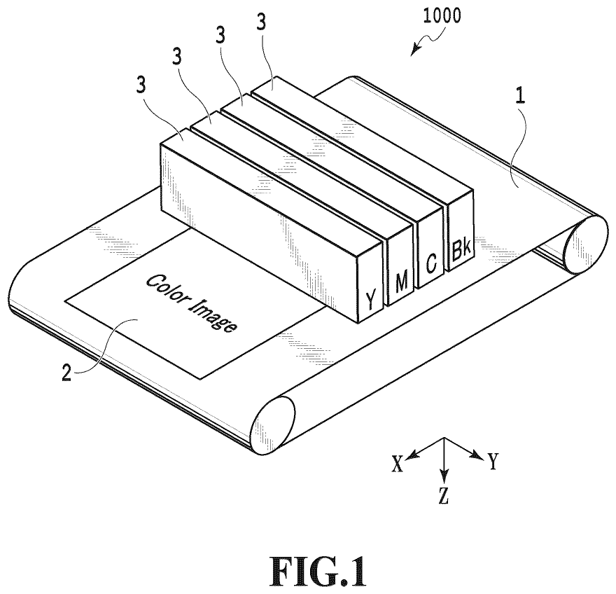

FIG. 1 shows a liquid ejection apparatus 1000 according to the present embodiment. In the figure, an X direction is a conveyance direction of a printing medium 2, a Y direction is a width direction of the printing medium 2, and a Z direction is a vertical direction. The liquid ejection apparatus 1000 of the present embodiment includes a paper conveyance unit 1 that conveys the printing medium 2 and a line-type liquid ejection head 3 that is disposed substantially orthogonal to the X direction, which is the conveyance direction of the printing medium 2. The liquid ejection head 3 can print a color image on the printing medium 2 by ejecting inks of cyan (C), magenta (M), yellow (Y), and black (Bk). The four liquid ejection heads 3 are arranged in the X direction in the order of cyan, magenta, yellow, and black, and the inks are applied to the printing medium 2 in this order. In each liquid ejection head 3, multiple ejection openings for ejecting ink are arranged in the Y direction.

Although cut paper is shown as the printing medium 2 in FIG. 1, the printing medium 2 may be continuous paper supplied from a roll of paper. Further, the printing medium is not limited to paper, and may be a film or the like.

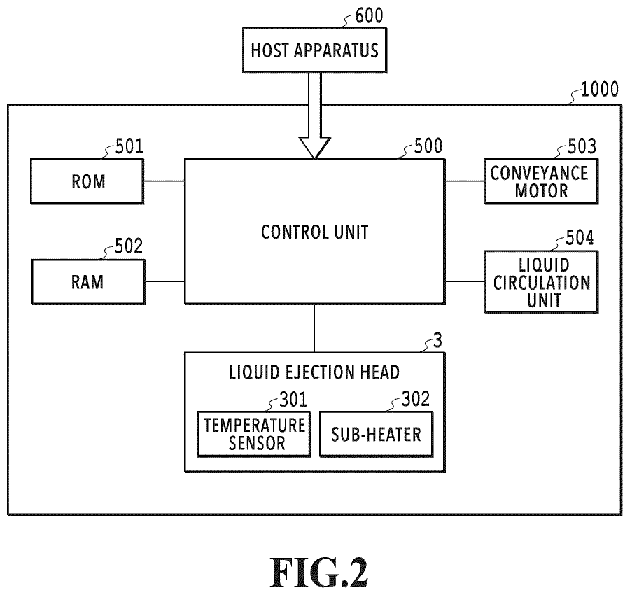

FIG. 2 is a block diagram for explaining a configuration of control in the liquid ejection apparatus 1000. The control unit 500 includes a CPU and the like, and controls the entire liquid ejection apparatus 1000 by using a RAM 502 as a work area according to a program and various parameters stored in a ROM 501. The control unit 500 performs predetermined image processing on image data received from a host apparatus 600 connected to the outside according to the program and parameters stored in the ROM 501, and generates ejection data that can be ejected by the liquid ejection head 3. Then, the liquid ejection head 3 is driven according to the ejection data, and the ink is ejected at a predetermined frequency.

During the ejection operation by the liquid ejection head 3, the control unit 500 drives a conveyance motor 503 to convey the printing medium 2 in the X direction at a speed corresponding to the driving frequency. As a result, an image according to the image data received from the host apparatus 600 is printed on the printing medium 2. In the ROM 501, information on a use area of the ejection opening used for ejection in the liquid ejection head 3 is stored for each liquid ejection head 3 so as to be rewritable. A method for setting the use area will be described later in detail.

### <Ink Circulation System>

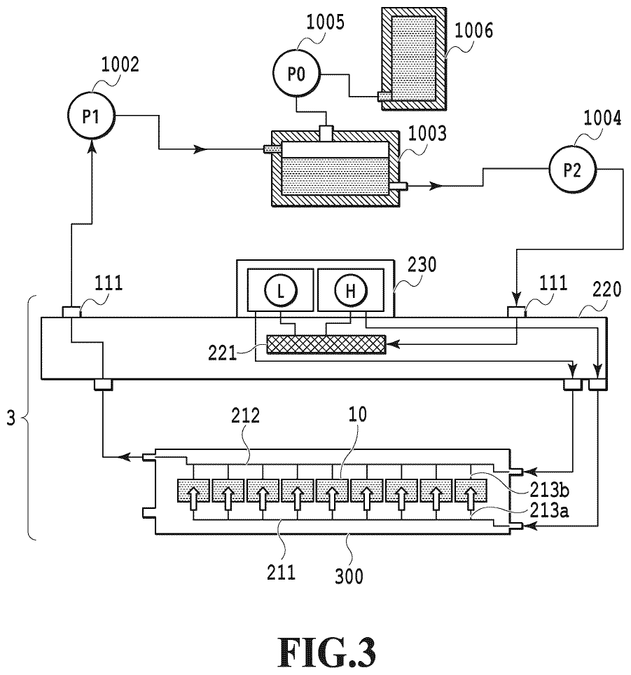

FIG. 3 is a schematic diagram illustrating a circulation path applied to the liquid ejection apparatus of the present embodiment, and illustrates the liquid ejection head 3 being fluidly connected to a first circulation pump 1002, a buffer tank 1003, and the like. Although only a path through which the ink of one color of the CMYK inks flows is shown in FIG. 3 for simplification of explanation, circulation paths corresponding to multiple colors are actually provided in the liquid ejection head 3 and the liquid ejection apparatus body. The buffer tank 1003 as a sub-tank connected to the main tank 1006 has an atmosphere communication port (not shown) that allows communication between the inside and outside of the tank, and can discharge bubbles in the ink to the outside. The buffer tank 1003 is also connected to a replenishment pump 1005. The replenishment pump 1005 transfers the amount of consumed ink from the main tank 1006 to the buffer tank 1003 when the liquid is consumed in the liquid ejection head 3 by ejecting (discharging) the ink from the ejection opening of the liquid ejection head due to printing by ejecting the ink, suction recovery, or the like.

The first circulation pump 1002 has a role of drawing liquid from the liquid connection portion 111 of the liquid ejection head 3 and flowing the liquid to the buffer tank 1003. During driving of the liquid ejection head 3, a certain amount of ink flows through the common recovery flow path 212 by the first circulation pump 1002.

The negative pressure control unit 230 is provided between the second circulation pump 1004 and the liquid ejection unit 300. Therefore, the negative pressure control unit 230 has a function to operate so that it maintains the pressure on the downstream side (liquid ejection unit 300 side) of the negative pressure control unit 230 at a predetermined pressure even when the flow rate of the circulation system fluctuates due to a difference in duty for printing.

As shown in FIG. 3, the negative pressure control unit 230 includes two pressure adjusting units each set to a different control pressure. Of the two negative pressure adjusting units, the relatively high-pressure setting side (denoted by H in FIG. 3) and the relatively low-pressure side (denoted by L in FIG. 3) are respectively connected to the common supply flow path 211 and the common recovery flow path 212 in the liquid ejection unit 300 via the liquid supply unit 220. The liquid ejection unit 300 is provided with an individual supply flow path 213a and an individual recovery flow path 213b communicating with the common supply flow path 211, the common recovery flow path 212, and each printing element substrate. Since the individual flow path 213 communicates with the common supply flow path 211 and the common recovery flow path 212, a part of the liquid flowing through the second circulation pump 1004 passes through the internal flow path of the printing element substrate 10 from the common supply flow path 211, and flows into the common recovery flow path 212 (arrow in FIG. 3). This is because a pressure difference is provided between the pressure adjusting unit H connected to the common supply flow path 211 and the pressure adjusting unit L connected to the common recovery flow path 212, and the first circulation pump 1002 is connected only to the common recovery flow path 212.

Therefore, the liquid is supplied from the supply system of the liquid ejection apparatus 1000 to the liquid ejection head 3, and the liquid that has passed through the liquid ejection head 3 is recovered to the supply system of the liquid ejection apparatus 1000. Thereby, the liquid can circulate through the path of the liquid ejection apparatus 1000 and the path of the liquid ejection head 3. In the liquid ejection unit 300 of the present embodiment, a flow of liquid passing through the common recovery flow path 212 and a flow from the common supply flow path 211 through each printing element substrate 10 to the common recovery flow path 212 are generated. Therefore, the heat generated in each printing element substrate 10 can be discharged to the outside of the printing element substrate 10 by the flow from the common supply flow path 211 to the common recovery flow path 212. Such a configuration makes it possible that while the printing is performed by the liquid ejection head 3, the ink flow can be generated even in the ejection openings and the pressure chambers where the printing is not performed, so that an increase in viscosity of the ink at those portions can be suppressed. The thickened ink and foreign matter in the ink can be discharged to the common recovery flow path 212. For this reason, the liquid ejection head 3 of the present embodiment can perform printing at high speed and with high image quality.

### <Configuration of Liquid Ejection Head>

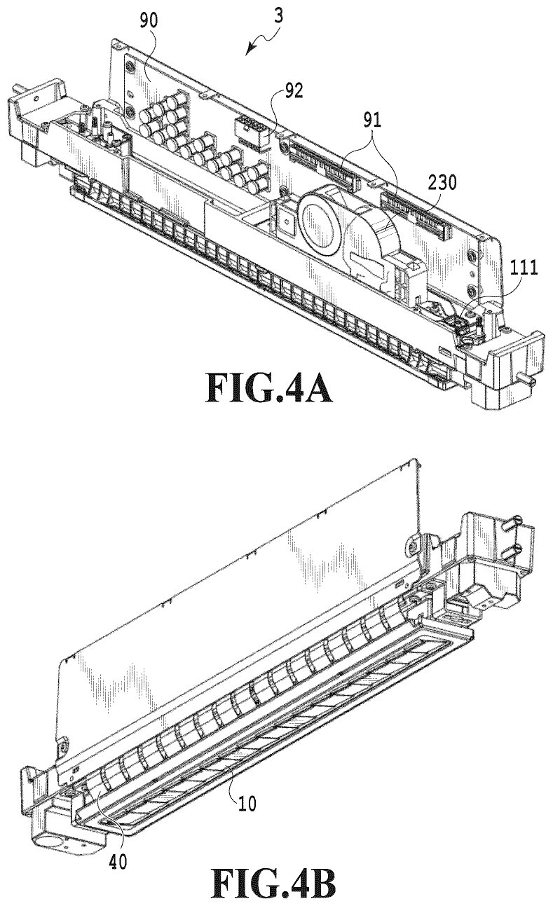

FIGS. 4A and 4B are perspective views of the liquid ejection head 3 according to the present embodiment. FIG. 5 is an exploded perspective view of FIGS. 4A and 4B. The liquid ejection head 3 is a line-type liquid ejection head in which 17 printing element substrates 10 capable of ejecting ink are arranged in a straight line (arranged in-line). As shown in FIGS. 4A and 4B, the liquid ejection head 3 includes a signal input terminal 91 and a power supply terminal 92 electrically connected to each printing element substrate 10 via a flexible wiring board 40 and an electrical wiring board 90. The signal input terminal 91 and the power supply terminal 92 are electrically connected to the control unit of the liquid ejection apparatus 1000, and supply an ejection drive signal and power necessary for ejection to the printing element substrate 10, respectively. By aggregating wirings by an electric circuit in the electrical wiring board 90, the number of signal input terminals 91 and power supply terminals 92 can be reduced as compared with the number of printing element substrates 10. Accordingly, the number of electrical connection portions that need to be removed when the liquid ejection head 3 is assembled to the liquid ejection apparatus 1000 or when the liquid ejection head is replaced may be small.

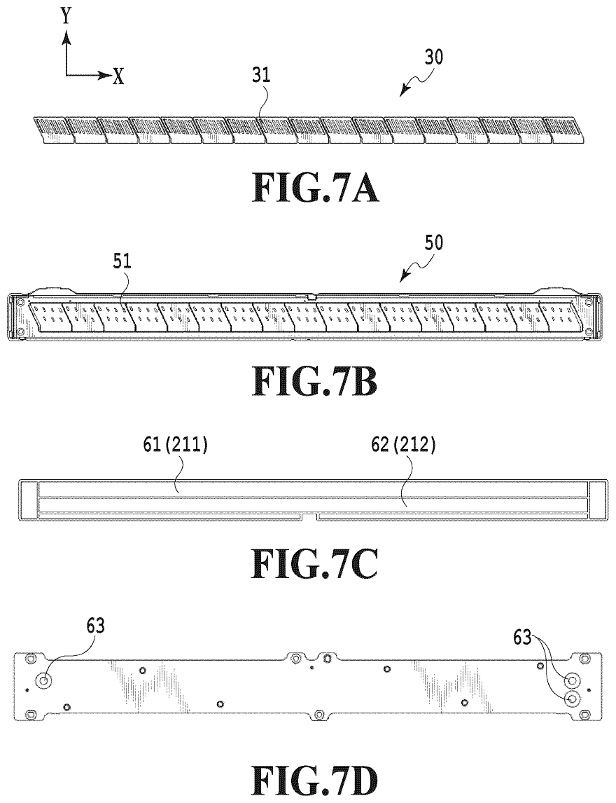

The housing 80 includes a liquid ejection unit support portion 81 and an electrical wiring board support portion 82, supports the liquid ejection unit 300 and the electrical wiring board 90, and ensures rigidity of the liquid ejection head 3. The electrical wiring board support portion 82 is for supporting the electrical wiring board 90, and is fixed to the liquid ejection unit support portion 81 with screws. The liquid ejection unit support portion 81 is provided with openings 83 and 84 into which joint rubbers 100 are inserted. The liquid supplied from the liquid supply unit 220 is guided to the second flow path member 60 constituting the liquid ejection unit 300 via the joint rubber 100. In the present embodiment, the flow directions of the common supply flow path 211 and the common recovery flow path 212 (see FIG. 7C) are the same, but the present disclosure is applicable even if the flow directions are opposite. As described above, the liquid ejection unit (head body) 300 includes the flow path member 210 including the first flow path member 50 and the second flow path member 60, and multiple ejection modules 200 including the printing element substrate 10.

Next, a configuration of the flow path member 210 included in the liquid ejection unit 300 will be described. As shown in FIG. 5, the flow path member 210 is formed by laminating a first flow path member 50 and a second flow path member 60, and the multiple ejection modules 200 are bonded to a joint surface of the first flow path member 50 with an adhesive (not shown). Thereby, the liquid supplied from the liquid supply unit 220 is distributed to each ejection module 200. Further, the flow path configuration is such that the liquid circulating from the ejection module 200 flows into the common recovery flow path 212 in the flow path member, and is discharged to the outside of the head through the liquid connection portion 111 of the liquid ejection head 3. The flow path member 210 is fixed to the liquid ejection unit support portion 81 with screws.

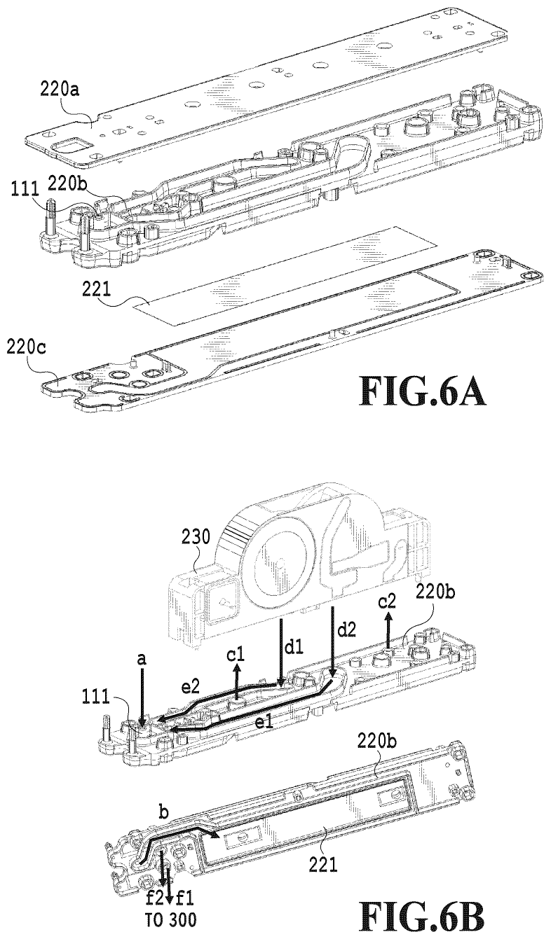

In the configuration of the liquid ejection head 3 described above, the liquid supply unit 220 is approximately half the length of the flow path member 210 constituting the liquid ejection unit 300, as indicated by an interval between two auxiliary lines indicated by dashed-dotted lines in FIG. 5. Thereby, a region where the liquid supply unit 220 and the flow path member 210 are directly or indirectly contacted via another member can be limited to a part of the length of the liquid ejection unit 300, and the amount of heat transferred from the liquid ejection unit 300 through the flow path member 210 to the liquid supply unit 220 can be suppressed. As a result, an increase in temperature of the ink supplied from the liquid supply unit 220 can be suppressed, and an increase in viscosity of the ink and other related issues due to an increase in temperature at the ink ejection portion of the liquid ejection unit 300 can be prevented. The length of the liquid supply unit 220 is not limited to ½ described above. From the viewpoint of suppressing the amount of heat transferred to the liquid supply unit 220, the shorter the length of the liquid supply unit 220 is, the better it is, such as ½ or less described above. However, in order to ensure that the area of the filter 221 (see FIGS. 6A and 6B) is at least a certain size, the length of the liquid supply unit 220 is preferably at least ¼ of the length of the liquid ejection unit 300. By ensuring that the area of the filter 221 is at least a certain size, it is possible to suppress stagnation of liquid flow. Further, since the ink flow in the common flow path in the first flow path member 50 constituting the flow path member 210 is from the left (upstream side) to the right (downstream side) in FIG. 5, the ink in the common flow path receives more heat from the liquid ejection unit 300 on the downstream side. Therefore, disposing the liquid supply unit 220 on the upstream side (between the two auxiliary lines) is effective in further reducing the amount of heat transferred to the liquid supply unit 220.

FIG. 6A is an exploded perspective view of the liquid supply unit 220, and FIG. 6B is an explanatory diagram illustrating a flow of liquid in the liquid supply unit 220. The liquid supply unit 220 includes an upper cover portion 220a in contact with the negative pressure control unit 230, a liquid supply unit body portion 220b, a filter 221, and a lower cover portion 220c. The liquid supply unit 220 is disposed in the order of the upper cover portion 220a, the liquid supply unit body portion 220b, the filter 221, and the lower cover portion 220c.

The upper cover portion 220a has multiple openings. In the present embodiment, the upper cover portion 220a has five openings. Thereby, the upper cover portion 220a can flow the liquid from the first circulation pump 1002 to the negative pressure control unit 230. The liquid supply unit body portion 220b includes a liquid connection portion 111, two openings for feeding liquid to the negative pressure control unit 230, and two flow paths for feeding liquid discharged from the negative pressure control unit 230 to the liquid ejection unit 300. The lower cover portion 220c includes a flow path for feeding the liquid passed through the filter 221 and the negative pressure control unit 230 to the flow path member 210.

Next, the flow of liquid in the liquid supply unit 220 will be described. As shown in FIG. 6B, the liquid flows in from the liquid connection portion 111 in the liquid supply unit 220 (arrow a) and flows on the back side of the liquid supply unit body portion 220b (arrow b). Then, the liquid passes through the filter 221 to remove foreign matter in the supplied liquid, and flows into the negative pressure control unit 230 disposed on the front side of the liquid supply unit body portion 220b (arrows c1 and c2). The negative pressure control unit 230 includes units having pressure regulating valves and uses the action of a valve, a spring member, or the like in each of the units to drastically attenuate a pressure loss change in the supply system (the upstream supply system of the liquid ejection head 3) of the liquid ejection apparatus 1000, which may occur with variation in the flow rate of the liquid. Then, the negative pressure control unit 230 can stabilize the negative pressure change on the downstream side (liquid ejection unit 300 side) of the pressure control unit within a certain range. The ink (arrows d1 and d2) flowing out of the negative pressure control unit 230 flows in the longitudinal direction of the liquid supply unit 220 (arrows e1 and e2) and flows into the liquid ejection unit 300.

As described in FIG. 6B, the filter 221 is desirably disposed upstream of the negative pressure control unit 230. Thereby, even when the pressure loss increases over time due to clogging or the like of the filter 221, the pressure in the head can be kept constant. Further, two pressure regulating valves are built in the negative pressure control unit 230, and are each set to different control pressures. By communicating the high-pressure side with the common supply flow path 211 in the liquid ejection unit 300 and the low-pressure side with the common recovery flow path 212 via the liquid supply unit 220, the ink circulation in the pressure chamber described above is enabled.

As described above, the ink flowing into the head body passes through the inside of the liquid supply unit that is directly or indirectly in contact with the liquid ejection unit 300 heated by receiving the heat from the printing element substrate, and thus the ink is heated in the liquid supply unit. On the other hand, by adopting a configuration in which the supply unit 220 is directly or indirectly in contact with only a part of the first flow path member and the second flow path member, the ink temperature rise in the supply unit can be reduced.

FIGS. 7A to 7D are diagrams for explaining a detailed configuration of the flow path member 210. FIG. 7A shows a contact surface of the support member 30 with the printing element substrate 10, FIG. 7B shows a contact surface of the first flow path member 50 with the support member 30, FIG. 7C shows a middle layer cross section of the first flow path member, and FIG. 7D shows a surface of the second flow path member on the liquid ejection unit support portion 81 side. FIGS. 7A to 7C are views seen from the ejection opening surface, and FIG. 7D is a view seen from the opposite side, that is, the liquid ejection unit support portion 81 side.

Multiple support members 30 arranged in the Y direction are disposed on the first flow path member 50, and one printing element substrate 10 is disposed on each support member 30. With such a configuration, the liquid ejection head 3 of various sizes can be assembled by adjusting the number of ejection modules 200 arranged.

As shown in FIG. 7A, a support member communication port 31 is formed in the surface of the support member 30 in contact with the printing element substrate 10, which is in fluid communication with the printing element substrate 10 and serves as the individual supply flow path 213a and the individual recovery flow path 213b described in FIG. 3. As shown in FIG. 7B, the support member communication port 31 is in fluid communication with the common supply flow path 211 or the common recovery flow path 212 through a communication port 51 formed in the flow path member 50.

As shown in FIG. 7C, in the middle layer of the first flow path member 50, there are formed common flow path grooves 61 and 62 extending in the Y direction, which serve as the common supply flow path 211 and the common recovery flow path 212 described in FIGS. 7A and 7B. As shown in FIG. 7D, common communication ports 63 in fluid communication with the liquid supply unit 220 are formed at both ends or one end of the common flow path grooves 61 and 62.

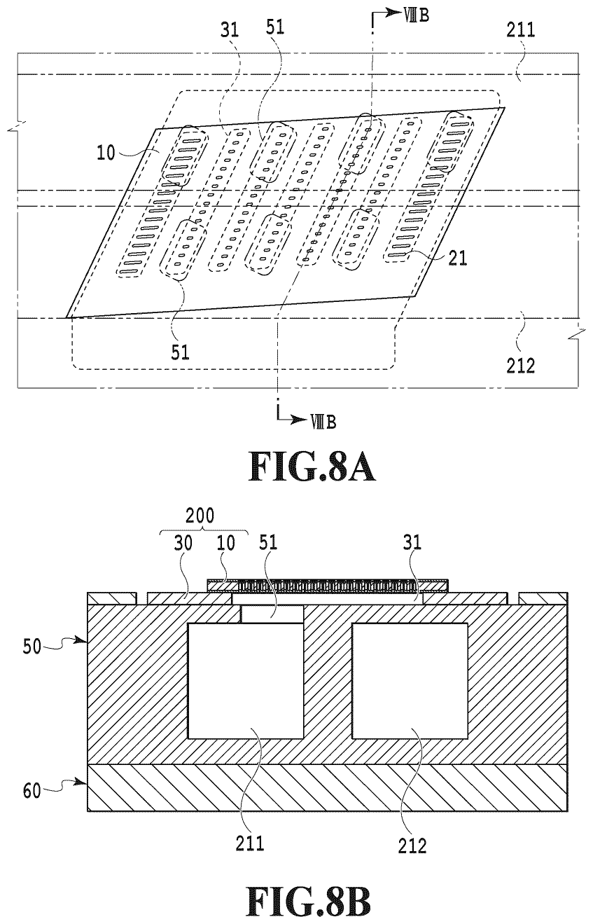

FIGS. 8A and 8B are a perspective view and a cross-sectional view for explaining a flow path structure formed inside the flow path member 210, the support member 30, and the cover plate 20. FIG. 8A is an enlarged perspective view of the flow path member 210, the support member 30, and the cover plate 20 as viewed from the Z direction, and FIG. 8B is a cross-sectional view taken along line VIIIB-VIIIB in FIG. 8A.

The printing element substrate 10 of the ejection module 200 is placed on the communication port 51 of the first flow path member 50 via the support member 30. Although the communication port 51 corresponding to the common recovery flow path 212 is not shown in FIG. 8B, it is apparent from FIG. 8A that the communication port 51 is shown in another cross section.

As described above, the common supply flow path 211 is connected to the first negative pressure control unit 230 having a relatively high pressure, and the common recovery flow path 212 is connected to the second negative pressure control unit 230 having a relatively low pressure. An ink supply path is formed that supplies ink to a flow path formed in the printing element substrate 10 through the common communication port 63 (see FIG. 7D), the common supply flow path 211, and the support member communication port 31. Similarly, an ink recovery path is formed from the flow path in the printing element substrate 10 to the support member communication port 31, the communication port 51, the common recovery flow path 212, and the common communication port 63 (see FIG. 8B). While the ink is circulated in this way, the printing element substrate 10 performs an ejection operation according to ejection data, and the ink that is not consumed by the ejection operation out of the ink supplied through the ink supply path is recovered by the ink recovery path.

### <Description of Ejection Module>

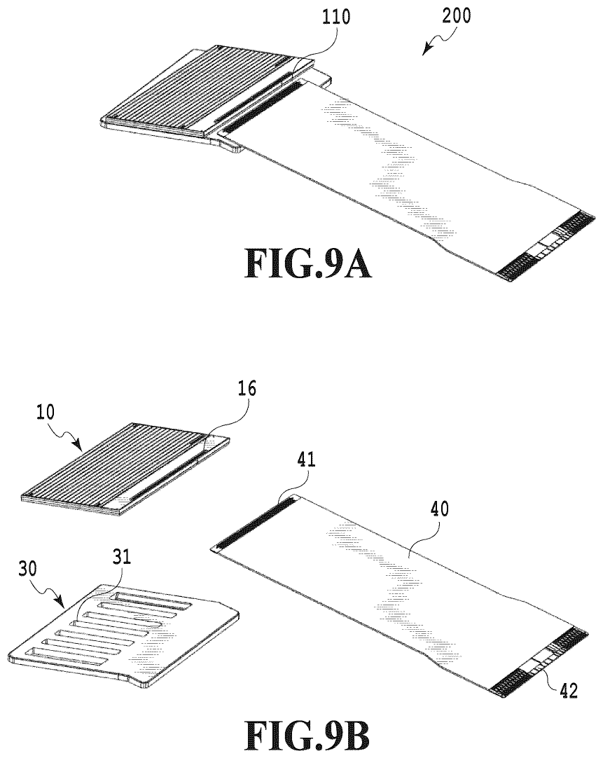

FIG. 9A is a perspective view showing one ejection module 200, and FIG. 9B is an exploded view thereof. As a method of manufacturing the ejection module 200, first, the printing element substrate 10 and the flexible wiring board 40 are bonded onto the support member 30 provided with the liquid support member communication port 31 in advance. Thereafter, the terminal 16 on the printing element substrate 10 and the terminal 41 on the flexible wiring board 40 are electrically connected by wire bonding, and then the wire bonding portion (electrical connection portion) is covered with a sealant 110 and sealed. A terminal 42 on the opposite side of the flexible wiring board 40 from the printing element substrate 10 is electrically connected to a connection terminal 93 (see FIG. 5) of the electrical wiring board 90. The support member 30 is a support body that supports the printing element substrate 10 and is also a flow path member that fluidly connects the printing element substrate 10 and the flow path member 210; therefore, the support member 30 preferably has high flatness and can be joined to the printing element substrate with sufficiently high reliability. For example, alumina or a resin material is preferable as the material.

### <Description of Structure of Printing Element Substrate>

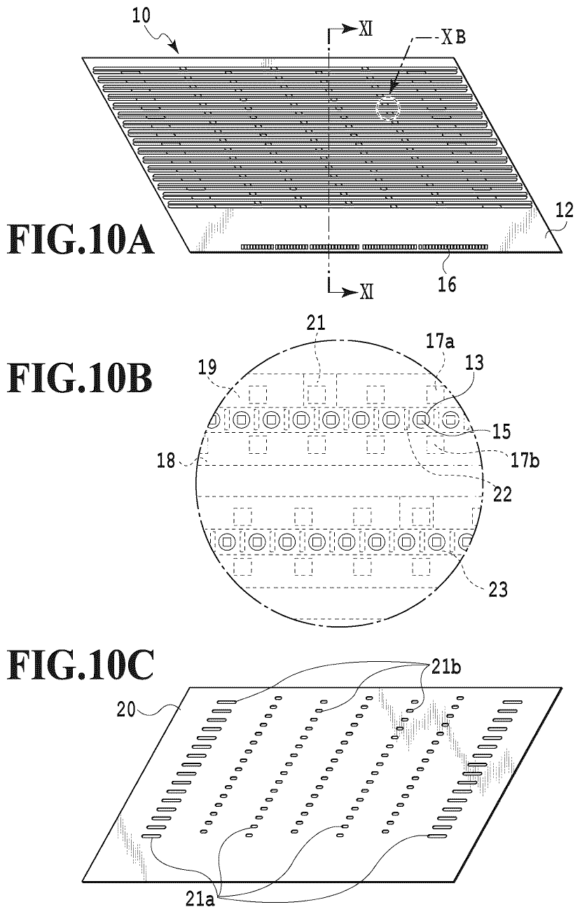

FIG. 10A is a plan view of the surface of the printing element substrate 10 on the side where the ejection openings 13 are formed, FIG. 10B is an enlarged view of a portion indicated by XB in FIG. 10A, and FIG. 10C is a plan view of the back surface of FIG. 10A. Here, a configuration of the printing element substrate 10 in the present embodiment will be described. Hereinafter, a direction in which ejection opening rows with multiple arranged ejection openings 13 extend will be referred to as “ejection opening row direction”. As shown in FIG. 10B, a printing element 15, which is a heating element (pressure generating element) for foaming liquid by utilizing thermal energy generated by the printing element 15, is disposed at a position corresponding to each ejection opening 13. A pressure chamber 23 including the printing element 15 inside is defined by a partition wall 22. The printing element 15 is electrically connected to the terminal 16 by an electrical wiring (not shown) provided in the printing element substrate 10. Then, the printing element 15 generates heat based on a pulse signal inputted from the control circuit of the liquid ejection apparatus 1000 via the electrical wiring board 90 (see FIG. 5) and the flexible wiring board 40 (see FIG. 9B) to boil the liquid. The liquid is ejected from the ejection opening 13 by the foaming force by the boiling. As shown in FIG. 10B, a liquid supply path 18 extends on one side and a liquid recovery path 19 extends on the other side along each ejection opening row. The liquid supply path 18 and the liquid recovery path 19 are flow paths extending in the ejection opening row direction provided in the printing element substrate 10, and communicate with the ejection opening 13 via a supply port 17a and a recovery port 17b, respectively.

As shown in FIG. 10C, a sheet-like cover plate 20 is laminated on the back of the surface of the printing element substrate 10 where the ejection opening 13 is formed, and multiple openings 21 communicating with the liquid supply path 18 and the liquid recovery path 19, which will be described later, are provided in the cover plate 20. In the present embodiment, four supply openings 21a are provided in the cover plate 20 for one liquid supply path 18, and three recovery openings 21b are provided in the cover plate 20 for one liquid recovery path 19; however, the number of openings is not limited to this. As shown in FIG. 10B, each opening 21 of the cover plate 20 communicates with the communication port 51 shown in FIG. 8A. The cover plate 20 preferably has sufficient corrosion resistance to liquid, and high accuracy is required for an opening shape and an opening position of the opening 21 so that the ink can be supplied to the pressure chamber.

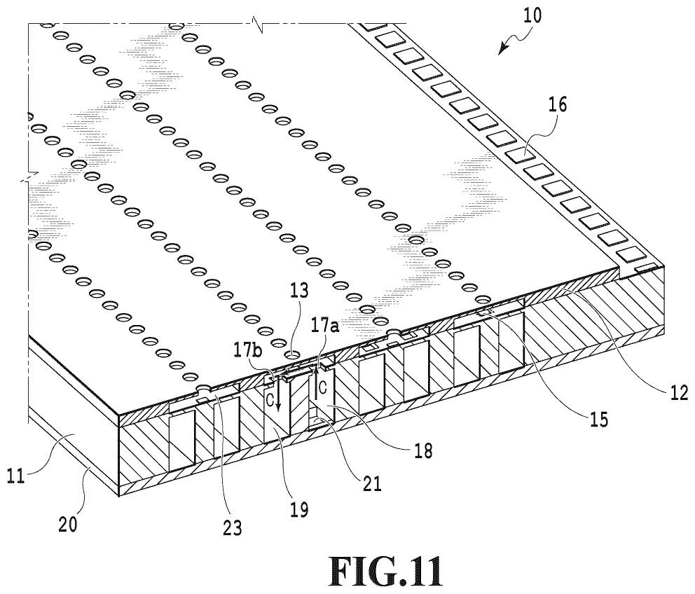

FIG. 11 is a perspective view showing a cross section of the printing element substrate 10 and the cover plate 20 taken along line XI-XI in FIG. 10A. Although four ejection opening rows are illustrated in the ejection opening forming member 12 of the printing element substrate 10 in FIG. 11, the present disclosure may have more or less ejection opening rows. Here, the flow of liquid in the printing element substrate 10 will be described. The cover plate 20 functions as a lid that forms a part of the walls of the liquid supply path 18 and the liquid recovery path 19 formed in the substrate 11 of the printing element substrate 10. The printing element substrate 10 is formed by laminating a substrate 11 formed of Si or the like and an ejection opening forming member 12 formed of a photosensitive resin, and the cover plate 20 is bonded to the back surface of the substrate 11. The printing element 15 is formed on one surface side of the substrate 11 (see FIG. 10B), and grooves constituting the liquid supply path 18 and the liquid recovery path 19 extending along the ejection opening row are formed on the back surface side thereof. The liquid supply path 18 and the liquid recovery path 19 formed by the substrate 11 and the cover plate 20 are connected to the common supply flow path 211 and the common recovery flow path 212 in the flow path member 210, respectively, and a differential pressure is generated between the liquid supply path 18 and the liquid recovery path 19. This differential pressure causes the liquid in the liquid supply path 18 provided in the substrate 11 to flow to the liquid recovery path 19 via the supply port 17a, the pressure chamber 23, and the recovery port 17b (arrow C in FIG. 11). Due to this flow, thickened ink, bubbles, foreign matter, and the like generated by evaporation from the ejection opening 13 in the ejection opening 13 and the pressure chamber 23, where the ejection operation is not performed, can be recovered to the liquid recovery path 19. Further, it is possible to suppress the ink in the ejection opening 13 and the pressure chamber 23 from increasing in viscosity and the concentration of the color material from increasing. As shown in FIG. 8A, the liquid recovered to the liquid recovery path 19 is recovered in the order of the support member communication port 31, the communication port 51 of the first flow path member 50, and the common recovery flow path 212 through the opening 21 and the support member communication port 31 of the support member 30, and is recovered to the supply path of the liquid ejection apparatus 1000.

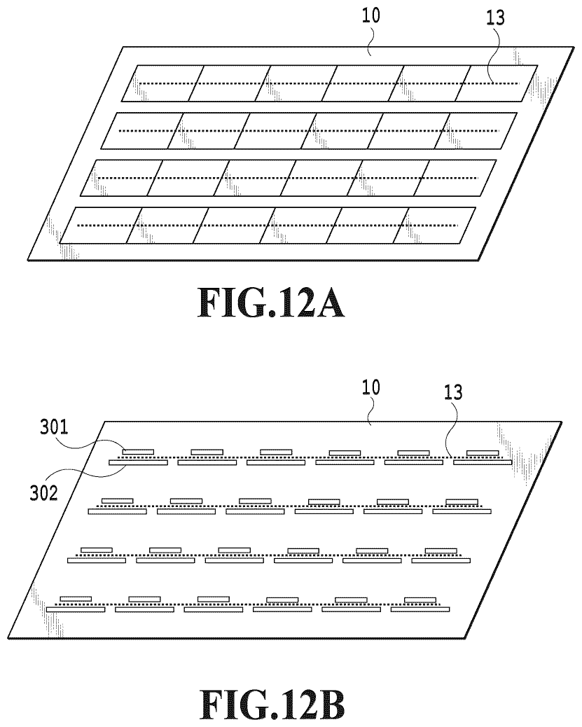

Note that FIGS. 12A and 12B schematically illustrate a state in which each printing element substrate 10 is partitioned into multiple areas for temperature adjustment. A temperature sensor 301 and a sub-heater 302 that can be individually controlled are provided for each area, and the control unit 500 (see FIG. 2) performs temperature adjustment based on the temperature set for each area using the temperature sensor 301 and the sub-heater 302. That is, the control unit 500 drives the sub-heater 302 only in the area where the detection temperature of the temperature sensor 301 is equal to or lower than the target temperature. By setting the target temperature of the printing element substrate 10 to a certain high temperature, it is possible to reduce the viscosity of the ink and to suitably perform the ejection operation and circulation. Further, by performing such temperature control to suppress the temperature variation in the printing element substrate 10 and the temperature variation among the multiple printing element substrates 10 within a predetermined range, the variation in ejection amount caused by the temperature variation can be reduced, thereby suppressing density unevenness in the printed image.

It is preferable from the viewpoint of image quality that the target temperature of the printing element substrate 10 be set to a temperature equal to or higher than the equilibrium temperature of the printing element substrate 10 in the case where all the printing elements 15 are driven at an assumed maximum driving frequency. As the temperature sensor 301, a diode sensor, an aluminum sensor, or the like is applicable.

Note that the printing element 15, which is a heating element, can also be used as a heating unit for the printing element substrate 10. Specifically, the printing element substrate 10 may be heated by applying a voltage to the printing element 15 that is insufficient to cause foaming. In the present embodiment, the printing element 15 may be adopted as the heating unit instead of the sub-heater 302, or the sub-heater 302 and the printing element 15 may be used in combination.

### OTHER EMBODIMENTS

Although the present embodiment illustrates a head that performs printing of one color with one head, the present disclosure is also applicable to multicolor heads that perform printing of multiple colors with one head.

Further, although the present embodiment is described on the premise of a commonly-known thermal head that ejects ink by heating the ink, the present disclosure is also applicable to liquid ejection heads using piezoelectric elements. This is because, even in a head using a piezoelectric element, a drive waveform generating circuit (IC) arranged to apply a drive waveform to the piezoelectric element generates heat, and thus, for example, when the IC is arranged near the printing element substrate, the same phenomenon as that in the thermal head described above occurs.

Furthermore, although the present embodiment shows a configuration (hereinafter, referred to as nozzle circulation configuration) in which the ink circulates through the pressure chamber 23 in the printing element substrate where the downstream temperature rise of the common flow path is particularly notable, the present disclosure is not limited to the nozzle circulation configuration.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-138733, filed Aug. 29, 2023, which is hereby incorporated by reference wherein in its entirety.

What is claimed is:

1. A liquid ejection head comprising:
a plurality of printing element substrates for ejecting a liquid;
a flow path member having a common flow path in fluid communication with the plurality of printing element substrates; and
a liquid supply unit that supplies the liquid to the flow path of the flow path member, the liquid supply unit being disposed on an opposite side of the flow path member from the printing element substrates,
wherein a length of the liquid supply unit in a longitudinal direction is shorter than a length of the flow path member in the longitudinal direction, and
a center of the liquid supply unit in the longitudinal direction is disposed closer to an upstream side of the common flow path than a center of the flow path member.

2. The liquid ejection head according to claim 1, wherein the length of the liquid supply unit in the longitudinal direction is ½ or less of the length of the flow path member in the longitudinal direction.

3. The liquid ejection head according to claim 2, wherein the length of the liquid supply unit in the longitudinal direction is ¼ or more of the length of the flow path member in the longitudinal direction.

4. The liquid ejection head according to claim 1, wherein the common flow path includes: a common supply flow path that directly or indirectly supplies the liquid to the plurality of printing element substrates; and a common recovery flow path that directly or indirectly recovers the liquid from the plurality of printing element substrates.

5. The liquid ejection head according to claim 4, wherein a flow direction of the liquid in the common supply flow path and a flow direction of the liquid in the common recovery flow path are the same.

6. The liquid ejection head according to claim 4, wherein a flow direction of the liquid in the common supply flow path and a flow direction of the liquid in the common recovery flow path are opposite to each other, and the center of the liquid supply unit in the longitudinal direction is disposed closer to an upstream side of the common recovery flow path than the center of the flow path member.

7. The liquid ejection head according to claim 1, further comprising a negative pressure controlling unit disposed on the opposite side of the flow path member from the printing element substrate.

8. The liquid ejection head according to claim 7, further comprising a filter disposed on the opposite side of the flow path member from the printing element substrate and an upstream side of the negative pressure controlling unit.

9. The liquid ejection head according to claim 8, wherein a length of the negative pressure controlling unit in the longitudinal direction is substantially half or more of the length of the liquid supply unit in the longitudinal direction.

10. The liquid ejection head according to claim 1, wherein each of the printing element substrates includes a pressure generating unit.

11. The liquid ejection head according to claim 10, wherein the pressure generating unit is a heating element.

12. The liquid ejection head according to claim 11, wherein the pressure generating unit is a piezoelectric element, and a drive circuit board for driving the piezoelectric element is disposed on a printing element substrate side of the flow path member.

13. A liquid ejection apparatus comprising:
a liquid tank that stores a liquid; and
a liquid ejection head that is connected to the liquid tank, the liquid ejection head including
a plurality of printing element substrates for ejecting the liquid,
a flow path member having a common flow path in fluid communication with the plurality of printing element substrates, and
a liquid supply unit that supplies the liquid to the flow path of the flow path member, the liquid supply unit being disposed on an opposite side of the flow path member from the printing element substrates,
wherein a length of the liquid supply unit in a longitudinal direction is shorter than a length of the flow path member in the longitudinal direction, and
a center of the liquid supply unit in the longitudinal direction is disposed closer to an upstream side of the common flow path than a center of the flow path member.
